(19) United States
(12) Patent Application Publication
(10) Pub. No.: US 2019/0096076 A1
(43) Pub. Date: Mar. 28, 2019

(54) METHOD AND DEVICE FOR ACTIVATING A DRIVER ASSISTANCE SYSTEM USING A STEREO CAMERA SYSTEM INCLUDING A FIRST AND A SECOND CAMERA

(71) Applicant: Robert Bosch GmbH, Stuttgart (DE)

(72) Inventor: Thomas Schoeberl, Hildesheim (DE)

(21) Appl. No.: 16/141,005

(22) Filed: Sep. 25, 2018

(30) Foreign Application Priority Data
Sep. 27, 2017 (DE) 102017217156.1

(51) Int. Cl. G06T 7/593; B60W 50/14

(52) U.S. Cl. CPC G06T 7/593; B60W 2420/42; G06T 2207/10012; B60W 50/14

(57) ABSTRACT

A method for activating a driver assistance system using a stereo camera system including a first and a second camera, the method including reading in, a first image from the first camera and a second image from the second camera being read in. The method furthermore includes forming, a cost function being created using the first and second images. Furthermore, in a further method step of determining, a periodicity parameter representing a periodic structure of an object to the stereo camera system is determined, using at least one local minimum of the cost function. Finally, the method includes using, the periodicity parameter being used to activate the driver assistance system.

### CROSS REFERENCE

The present application claims the benefit under 35 U.S.C. § 119 of German Patent Application DE 102017217156.1 filed on Sep. 27, 2017, which is expressly incorporated herein by reference in its entirety.

### BACKGROUND INFORMATION

The present invention is directed to a device and to a method for activating a driver assistance system. The present invention also relates to a computer program.

Stereo camera systems made up of two identical cameras oriented toward the same target objects are increasingly used for surroundings monitoring, in particular for driver assistance systems, since in this way the distance from objects may be ascertained via the perspective representation of the two camera images. Different methods may be used for determining the distance from two image pairs. The effect of the “periodic structures” in the image pairs, however, may in part cause problems in detecting a distance from objects which may result in an erroneous activation of a driver assistance system if the image pairs are used as a basis for the functions of the driver assistance system.

### SUMMARY

In accordance with the present invention, a method is provided for activating a driver assistance system using a stereo camera system including a first and a second camera, furthermore a device which uses this method, and finally a corresponding computer program.

Advantageous refinements of and improvements on the example device are described herein.

An example method in accordance with the present invention for activating a driver assistance system using a stereo camera system including a first and a second camera is provided, the method including the following steps:

reading in a first image from the first camera and a second image from the second camera;

forming a cost function, using the first and second images;

determining a periodicity parameter (for example of a cost function) representing a periodic structure of an object (for example from the stereo camera system), at least using a local minimum of the cost function;

using the periodicity parameter for activating the driver assistance system.

The driver assistance system may be an electronic additional unit in a vehicle for assisting the driver in certain driving situations. Interventions and/or hints with respect to vehicle safety, but also the enhancement of the driving comfort for the driver and further vehicle occupants may be carried out or output. The stereo camera system may be a camera system which includes at least two lenses provided next to one another and is thus able to record stereoscopic images. A cost function may be understood to mean a value calculated using a functional relationship, which represents disparities along the associated epipolar line and a depth distance. A cost function may thus represent a relationship between the calculated or virtual costs, for example of all disparities possible for a pixel of a base image along the associated epipolar line, and a depth distance of an object. A periodic structure in an image pair may have been caused, for example, by a lattice-shaped fence, guard rails or a corrugated sheet roof, which during the ascertainment of the cost function also results in a periodic structure in this cost function. A periodic structure within the cost function may be curves or sequences of function values which recur at regular intervals and have the same cost function values (within tolerance limits). The intervals between the occurrence of the same function values may be referred to as a period. A periodicity parameter may thus constitute or represent a characterizing variable of the periodic structure within a cost function or a measure of the periodicity of the cost function. A local minimum may represent a value of the cost function at a point in whose surroundings (on both sides) the cost function does not assume any smaller or lower values. The local minimum, however, does not necessarily have to be the global minimum of the entire cost function.

The approach in accordance with the present invention is based on the finding that, by evaluating the curve of the cost function, the periodicity parameter may be obtained in a technically simple and efficient manner as a parameter which provides an indication of periodic structures occurring in the image pair. In a simple manner, this allows a conclusion to be drawn of periodic structures occurring in the image pair which could result in a potentially erroneous function of the driver assistance system, for example carry out an erroneous distance warning or an erroneous emergency brake application. For identification, in particular the knowledge of the location of at least one local minimum may be used, since such a local minimum may be easily and reliably detected.

According to one specific embodiment, a sub-section of the first image may be compared to at least one further sub-section of the second image in the step of forming, in particular a row of the first image is compared to a row of the second image and/or a column of the first image being compared to a column of the second image. Advantageously, the processing of sub-sections may be carried out in rows and/or in columns, which may be implemented in a technically fast and simple manner.

According to one specific embodiment, in the step of determining, the cost function may be determined as a function of a disparity parameter representing the distance of the object from the stereo camera system. Furthermore, in the step of determining, the disparity parameter may also be used, which represents a reciprocal measure of the distance of the object from the stereo camera system. Such a specific embodiment of the approach described here offers the advantage of ascertaining a cost function which has a high degree of similarity of mapping parameters relevant for a driver assistance system, such as the distance of an object ahead of a vehicle, from vehicle surroundings. Since the calculation of a cost function based on a disparity value is computationally intensive, preferably simple and fast algorithms are used to prevent an unnecessary increase in the computing complexity by checking the cost function for a parameter representing a periodicity. The global minimum or a local minimum may generally be easily ascertained during the passage of the disparity curve or the cost function from left to right (i.e., during the ascertainment of the cost function values from small disparity values to large disparity values) without computationally intensive regressions. Checking the cost function for a parameter representing the periodicity may also be ascertained during the passage of the disparity curve or cost function from left to right (i.e., during the ascertainment of the cost function values from large disparity values to small disparity values) without regressions. A possible expansion of the method is to simultaneously ascertain a parameter representing the periodicity and the global minimum, and check a frontoparallelity of an object in the image pair.

According to one specific embodiment, in the step of determining furthermore at least one local maximum and a global minimum and a global maximum of the cost function may be determined, in particular the local maximum situated between the global and the local minimum. Such a specific embodiment of the approach described here offers the advantage of using suitable variables to obtain, through the periodicity parameter, reliable information which is technically simple to ascertain regarding the presence of a periodicity in the cost function or in corresponding sub-sections of an image pair.

According to one specific embodiment, in the step of determining, the periodicity parameter may be determined as a function of a difference of a value of the cost function at the local minimum and a value of the cost function at the local maximum. In this way, it is advantageously possible to identify how strongly the values of the cost function vary in the surroundings of the local minimum, to be able to draw a conclusion, for example, of the presence of interferences caused by image noise. According to this specific embodiment, a variable or the periodicity parameter is determined as a measure of the periodicity, which may be compared to a threshold value, for example, in a technically simple manner.

According to another specific embodiment, in the step of determining, the periodicity parameter may be determined as a function of a further difference of cost values of an adjoining further local maximum and a further local minimum. Such a specific embodiment also offers the advantage that a meaningful conclusion regarding the presence of a periodicity or a measure of the periodicity by using the further difference is able to be drawn.

According to one further specific embodiment, in the step of determining, the periodicity parameter may be determined as a function of a maximum of the difference and the further difference. As an alternative or in addition, in the step of determining, the periodicity parameter may be determined as a function of the further local maximum and the further local minimum, the global minimum being situated between the further local maximum and the further local minimum on the one hand, and the local maximum and the local minimum on the other hand. By using a dependence of the periodicity parameters on the difference and the further difference and/or location of the further minimum or the location of the further maximum, a higher precision or more precise information regarding the presence of a periodicity in the cost function or corresponding sub-sections in the image pair may be achieved.

According to one specific embodiment, in the step of determining, the periodicity parameter may be determined as a function of a value of the cost function at a local maximum and a value of the cost function at the global minimum. In particular, in the step of determining, the periodicity parameter may be determined as a function of a difference from a value of the cost function at the local maximum and the value of the cost function at the global minimum or a value of the cost function at the local maximum and a value of the cost function at the global minimum. This specific embodiment of the approach described here also offers a higher precision or more precise information regarding the presence of a periodicity in the cost function or corresponding sub-sections in the image pair.

According to one specific embodiment, in the step of determining, the periodicity parameter may be determined as a function of a ratio of a value of the cost function at the global minimum to a value of the cost function at the global maximum, in particular the ratio representing a measure of the periodicity of the cost function as a function of a threshold value. This specific embodiment of the approach described here also offers a higher precision or more precise information regarding the presence of a periodicity in the cost function or corresponding sub-sections in the image pair.

According to one specific embodiment, in the step of determining, the periodicity parameter may be formed as a bit value. It therefore requires only little memory space, may be transmitted quickly, and may also be evaluated well in other functions. In this way, furthermore a processing of this parameter, for example using a 2 bit shift operation, is implementable in a technically simple manner.

The method described here may be implemented, for example, in software or hardware or in a mixed form made up of software and hardware, for example in a control unit.

The approach described here also creates a device which is designed to carry out, activate or implement the steps of one variant of a method described here in corresponding units. The object underlying the present invention may also be achieved quickly and efficiently by this embodiment variant of the present invention in the form of a device.

For this purpose, the example device may include at least one processing unit for processing signals or data, at least one memory unit for storing signals or data, at least one interface to a sensor or an actuator for reading in sensor signals from the sensor or for outputting data signals or control signals to the actuator and/or at least one communication interface for reading in or outputting data which are embedded into a communication protocol. The processing unit may be a signal processor, a microcontroller or the like, for example, it being possible for the memory unit to be a Flash memory, an EEPROM or a magnetic memory unit. The communication interface may be designed to read in or output data wirelessly and/or in a wire-bound manner, a communication interface which is able to read in or output wire-bound data being able to read these data in, for example electrically or optically, from a corresponding data transmission line or output these into a corresponding data transmission line.

A device may presently be understood to mean an electrical device which processes sensor signals and outputs control and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially made up of discrete elements. In the case of a software design, the interfaces may be software modules which are present on a microcontroller, for example, in addition to other software modules.

In addition, a computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer or a device.

Exemplary embodiments of the present invention described here are shown in the figures and are described in greater detail below.

### BRIEF DESCRIPTION OF THE DRAWINGS

FIG. 1 shows a schematic representation of a stereo camera for use with a device according to one exemplary embodiment.

FIG. 2 shows an illustration to explain the determination of the disparity of the depth distance between the camera and the object according to one exemplary embodiment.

FIG. 3 shows a representation of an image in which one example of a periodic structure in the form of a pedestrian crossing having a corresponding disparity curve or cost function is represented.

FIG. 4 shows a diagram illustration of an ideal periodic structure of a cost function to explain a procedure for determining the periodicity parameter.

FIG. 5 shows a diagram illustration of a real periodic structure of a cost function to explain a procedure for determining the periodicity parameter according to one exemplary embodiment.

FIG. 6 shows a diagram illustration of a periodic structure of a cost function to explain a procedure for determining the periodicity parameter according to one exemplary embodiment.

FIG. 7 shows a flow chart of one exemplary embodiment of a method for activating a driver assistance system using a stereo camera system including a first and a second camera.

### DETAILED DESCRIPTION OF EXAMPLE EMBODIMENTS

In the following description of favorable exemplary embodiments of the present invention, identical or similar reference numerals are used for similarly acting elements shown in the different figures, and a repeated description of these elements is dispensed with.

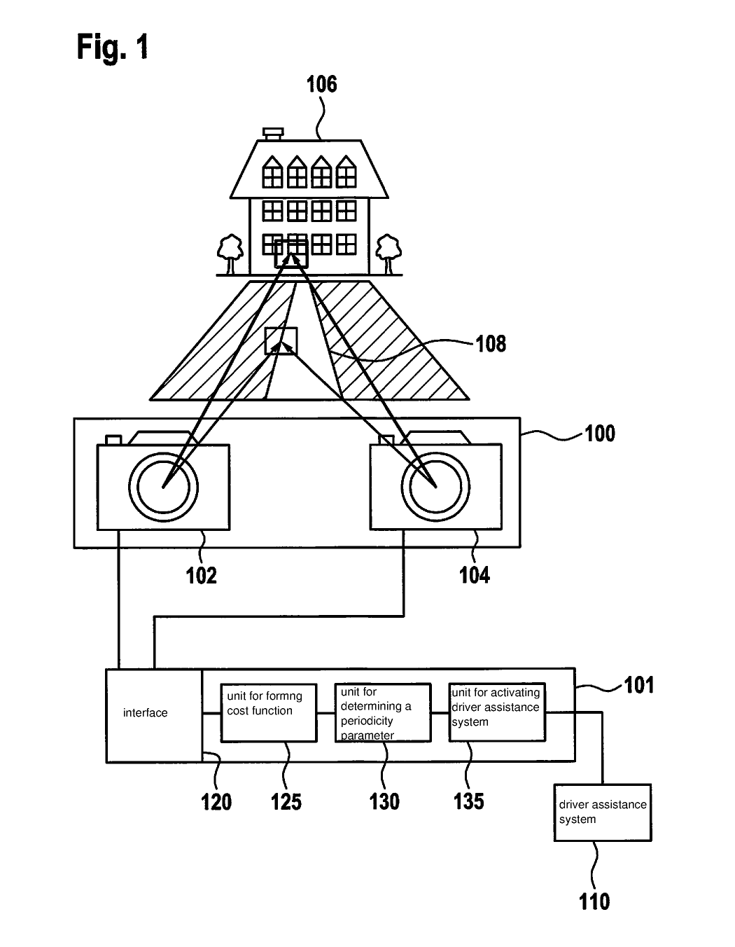

FIG. 1 shows a schematic representation of a stereo camera 100 for use with a device 101 according to one exemplary embodiment.

The drawing shows one example of a stereo camera system 100 made up of two identical cameras 102, 104, both cameras 102, 104 being oriented toward the same target object 106, a house 106 here, to which a path 108 leads. The two cameras 102, 104 record the same scene, i.e., house 106, from different spatial points of view. The distance of house 106 from stereo camera system 100 is to be ascertained via a perspective representation of the two camera images. The epipolar geometry describes the relationship between the two different camera images of the same target object 106. In this way, the dependence between the corresponding image points, i.e., the points which an individual object point generates in the two camera images, may be described. In addition to the distance of the object, such as house 106 here, the frontoparallelity of the object, of house 106 here, for example, may also be ascertained by the evaluation of the images of the two cameras 102 and 104. For example, in a portion of the images of the two cameras 102 and 104 which depict a section of house 106, it may be ascertained, for example, which orientation identified edges in the respective images have, so that an orientation of the object, such as house 106, with respect to cameras 102 and 104 of stereo camera system 100 may be ascertained therefrom. In contrast, for example, it may also be identified from a degree of inclination of the edge progressions of identified edges in the area of path 108 that this path 108 does not represent an object which is oriented in a frontoparallel manner with respect to the image recording plane of stereo camera system 100.

To be able to identify a periodic structure of an object, such as the rows of periodic windows in house 106, device 101 briefly mentioned above is used to activate a driver assistance system 110, using stereo camera system 100 including first 102 and second 104 camera. For this purpose, device 101 includes an interface 120 for reading in a first image from first camera 102, and a second image from second camera 104. Device 101 furthermore includes a unit 125 for forming a cost function using the first image and the second image, and a unit 130 for determining a periodicity parameter of a cost function representing a periodic structure of object 106, at least using a local minimum of the cost function. Finally, device 101 includes a unit 135 for using and/or outputting the periodicity parameter for activating driver assistance system 110.

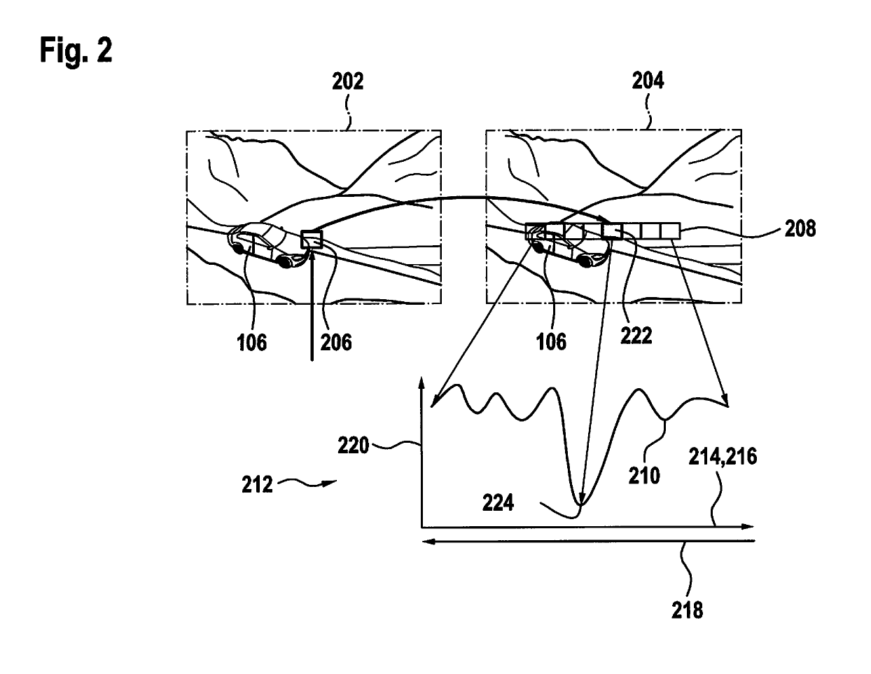

FIG. 2 shows an illustration to explain the determination of the disparity of the depth distance between the camera and the object according to one exemplary embodiment.

The illustration includes a first left image 202 (for example, of first camera 102 from FIG. 1 situated on the left) and a second right image 204 (for example, of second camera 104 from FIG. 1 situated on the right). In the two images, a target object 106 driving on a road, a vehicle here, is shown. First image 202 and second image 204 are shown in a rectified manner. First left image 202 shows a sub-section 206, which is sought in second image 204 based on a row and/or a column, which hereafter is referred to as epipolar line 208 (for example, of an identical column in right image 204). A cost function 210 is formed from these two sub-sections of the images, which is shown in the bottom sub-diagram from FIG. 2 in a coordinate system 212. In this, x axis 214 of coordinate system 212 represents an increasing disparity value 216 which, with increasing values, indicates a decreasing distance value 218, i.e., behaves reciprocally with respect to distance value 218, which increases in the direction of the arrow. In contrast, y axis 220 indicates a cost value on cost function 212 at the respectively assigned disparity value. The costs usually result from individual costs per image element (pixel), which are suitably aggregated across an area in the image (e.g., by summation). These costs are a measure of the similarity of an image area in the reference image and in the search image. The costs per pixel typically result directly from a similarity degree of the image intensities (absolute differences, difference square), the intensity gradients or further parametric (product-moment correlation) and non-parametric masses (e.g., rank correlation) or combinations thereof. In a local method, the aggregation of these pixel costs takes place by summation of the individual costs in an area of the image. This area may be constant across all calculations or may also be dynamically adapted to the respective image content.

In general, it may be noted that it is irrelevant in which direction the cost function is passed. What is important is that it is preferably passed only once for the calculation.

Different methods may be used for determining the distance from an image pair. Frequently, local methods are used which, in principle, search for a small sub-section 206 of first image 202 in a second rectified image 204 along epipolar line 208. The similarity of first sub-section 206 with further sub-section 222 of second image 204 along epipolar line 208 is represented as cost function 210. An extreme value, global minimum 224 here, of cost function 210 represents the disparity, i.e., for example, the offset of the identical image content, between first image 202 and second image 204. This disparity is a reciprocal measure of the distance of object 106 from camera. The shape of cost function 210, for example the value of global minimum 224, may be used for evaluating the quality of the disparity.

When the disparities of all sub-sections of left image 202 from the content of the right image 204 are determined, a disparity map, and thus a depth map, for the entire image may be created. Further methods may be applied to this depth map, for example to detect the surface or the location of objects, such as road surfaces, pedestrians or vehicles. In driver assistance systems, such as driver assistance system 110, the erroneous detection of objects could result in incorrect and dangerous driving maneuvers, for example an emergency brake application or an evasive maneuver.

Ideally, cost function 210 has a clearly detectable global minimum 224 having a steep rise. Further possible local minima, in terms of their costs, are far above the costs of global minimum 224. The position of global minimum 224 is sought-after disparity value 216. This ideal case, however, only occurs with ideal ambient conditions.

Periodic structures in cost function 210 are problematic in the evaluation of cost function 210 since these could result in an identification of global minimum 224 which is no longer unambiguous, specifically when the differences between the cost function values of the local minima are so low that these minima could also result from image interferences or other errors, for example. For this reason, the approach described here is to show a way as to how it may be identified that a periodic structure occurs in the cost function which, for example, is due to a periodic structure or a periodic pattern in the sub-sections of the image pairs to be evaluated. This may, for example, then result in a corresponding periodicity parameter, which represents an occurrence of such a periodic structure in the cost function, being ascertained and used to activate driver assistance system 110. For example, a threshold value for a steering intervention or an emergency braking intervention may be changed in driver assistance system 110 when a certain periodicity parameter provides an indication of the presence of a periodic structure in cost function 210 or in sub-sections of image pairs.

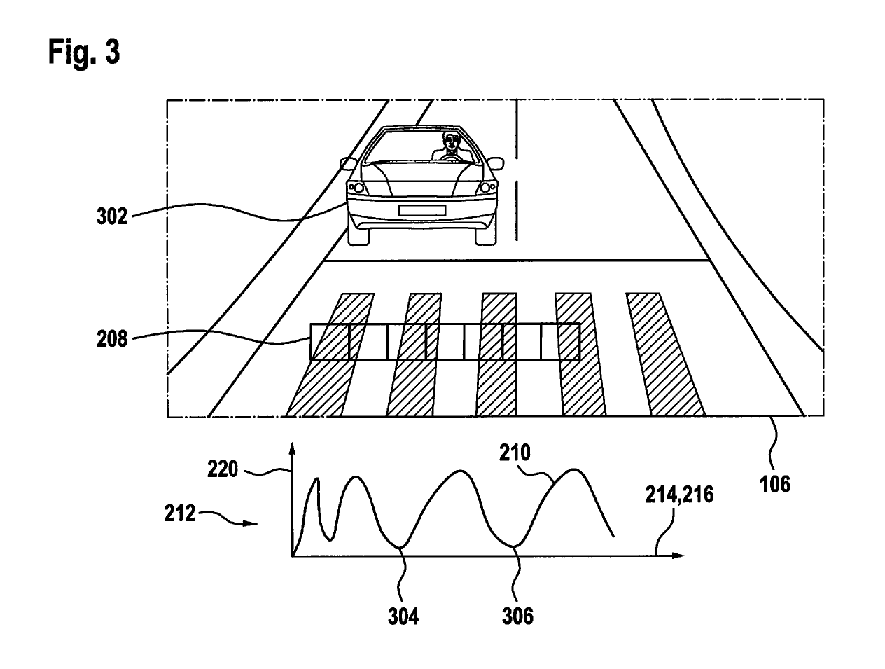

FIG. 3 shows a representation of an image in which one example of a periodic structure in the form of a pedestrian crossing having a corresponding disparity curve or cost function is represented.

The image shows a vehicle 302 driving on a road, which approaches target object 106, a crosswalk here. Furthermore, a function 210 and an epipolar line 208, which is situated on top of the illustration of target object 106, are shown. When the image shown in FIG. 3 is detected by two cameras of a stereo camera system, corresponding to the illustration from FIG. 2 two images results, in which the similarity of a first sub-section 206 from a first image with further sub-sections 222 along epipolar line 208 is ascertained and represented as cost function 210 within a coordinate system 212. In the illustration from FIG. 3, the sub-sections shown as boxes from epipolar line 208 would thus be used to obtain cost function 210 represented in the diagram shown at the bottom of FIG. 3.

In real surroundings as are shown in FIG. 3 by way of example, a wide variety of effects occur, which negatively affect the curve of cost function 210. In the real surroundings, objects exist, for example crosswalks, lattices or fences, which show similar image contents in different sub-sections. In the disparity calculation or the determination of cost function 210, a sub-section 206 of the first image may thus correlate with multiple sub-sections 222 of the second image. Cost function 210 then has a periodic structure including multiple minima 304, 306 having similar cost function values. The global minimum thus does not necessarily have to correspond to the sought-after disparity value 216. In real scenarios, the position of the global minimum is frequently not the sought-after disparity value, but that of a local minimum. In a pure evaluation of cost function 210 for the global minimum, an incorrect disparity value 216 would thus occur, and the distance of object 106 from the camera would thus be incorrectly determined. In driver assistance systems, such as driver assistance system shown in FIG. 1 with reference numeral 110, the erroneous detection of objects 106 may result in erroneous and dangerous driving maneuvers, such as an emergency brake application or a sudden evasive maneuver.

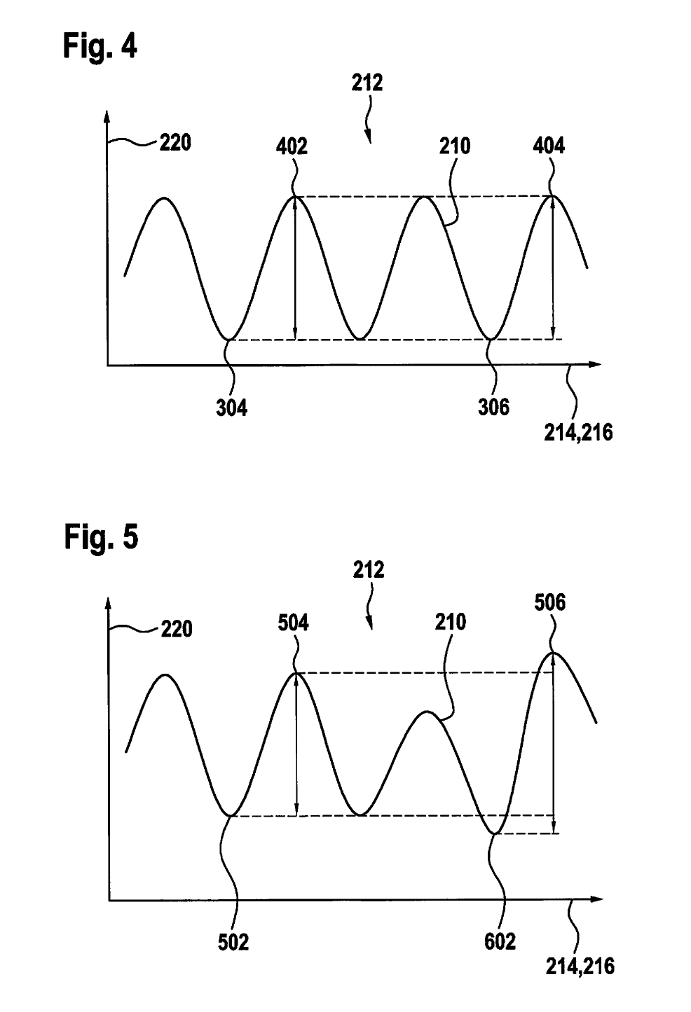

FIG. 4 shows a diagram illustration of an ideal periodic structure of a cost function 210 to explain a procedure for determining the periodicity parameter.

The diagram illustration includes a coordinate system 212, which indicates a cost function 210 having a periodic structure, which hereafter is also referred to as a periodic cost function 210. Here, x axis 214 of coordinate system 212 represents an increasing disparity value 216. In contrast, y axis 220 represents a cost function value. It is to be noted that, with an ideal periodic function, for example a sine curve, the cost function values of all maxima 402, 404 and all minima 304, 306 are identical, and thus the difference between two arbitrary minima 304, 306 and maxima 402, 404 is always the same.

In the approach of an evaluation of periodic cost function 210 described here, additionally a quality criterion in the form of the periodicity parameter is to be calculated or determined, which shows the existence of periodic structures in the disparity curve. With the aid of this quality criterion, it is possible to determine the plausibility of the global minimum, i.e., of the disparity. One aspect of the approach described here for the identification of periodic structures is based on the evaluation of cost function 210. This takes advantage of the fact that periodic structures in the image pairs also form periodic structures in cost function 210.

FIG. 5 shows a diagram illustration of a real periodic structure of a cost function 210 to explain a procedure for determining the periodicity parameter according to one exemplary embodiment.

The diagram illustration again includes a coordinate system 212, which indicates a cost function 210 having a periodic structure, which hereafter is also referred to as a periodic (cost) function 210. An (increasing) disparity value 216 is plotted on x axis 214 of coordinate system 212. In contrast, y axis 220 indicates a cost function value. Periodic (cost) function 210 has a local minimum 502, a local maximum 504, a global minimum 224 and a global maximum 506.

In a real periodic function 210, the difference between global minimum 224 and global maximum 506 is only slightly larger than a pair having a large distance between a local minimum 502 and a local maximum 504, local maximum 504 being situated between global minimum 224 and local minimum 502. The ratio of the difference from global minimum 224 and global maximum 506 to the difference from local minimum 502 and local maximum 504 represents a measure of the periodicity of function 210.

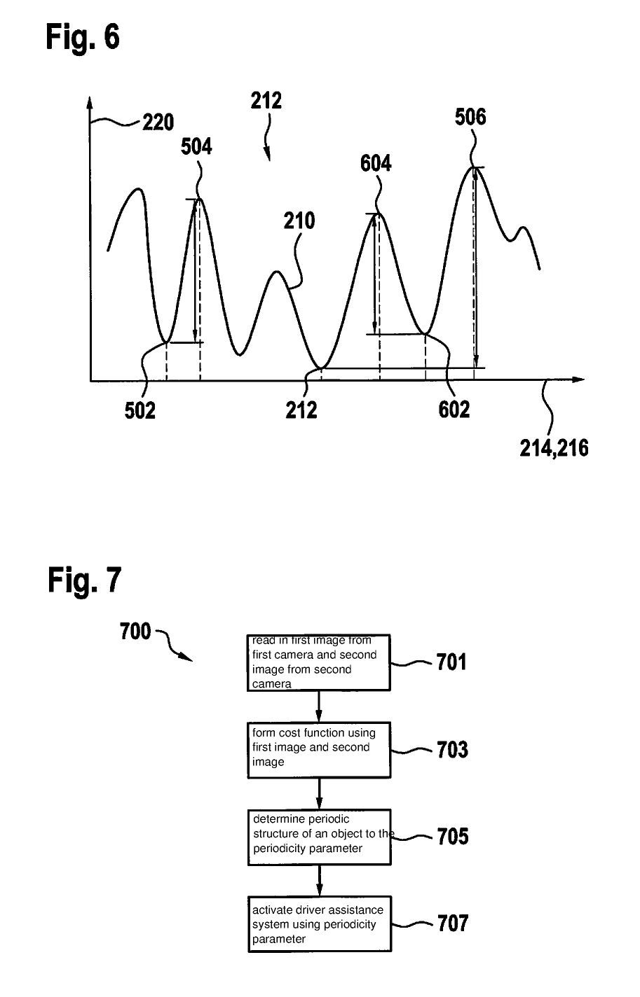

FIG. 6 shows a diagram illustration of a periodic structure of a cost function 210 to explain a procedure for determining the periodicity parameter according to one exemplary embodiment.

The diagram illustration shows a coordinate system 212, which indicates a cost function 210 having a periodic structure, which hereafter is also referred to as a periodic function 210. An (increasing) disparity value 216 is plotted on x axis 214 of coordinate system 212. In contrast, y axis 220 indicates a cost function value. Periodic function 210 has local minimum 502 and a further adjoining local minimum 602, local maximum 504 and a further adjoining local maximum 604, global minimum 224 and global maximum 506.

In a real (cost) function 210, minima 502, 602 and maxima 504, 604 occur in arbitrary positions. Since in a certain or sought-after pair, for example local minimum 502, 602 and local maximum 504, 604, local maximum 504, 604 is to be situated between local minimum 502, 602 and global minimum 224, it may occur on x axis 214, 216 to the left or the right of global minimum 224.

Since the order between local minimum 502, 602 and local maximum 504, 604 is reversed for the left and right pairs, this affects the algorithmic search. The realization of the implementation for the pair search may take place separately from one another. In this regard, the following procedure according to one favorable exemplary embodiment has proven suitable:

Initially, global minimum 224 and global maximum 506 are sought, and their cost difference is calculated. Subsequently, local minimum 502 and local maximum 504 having the maximum cost difference are sought, pair 502, 504 being situated before global minimum 224 on x axis 214, 216, and the local maximum being situated between local and global minima. Finally, local minimum 602 and local maximum 604 having the maximum cost difference are sought, the pair being situated after global minimum 224 on x axis 214, 216, and the local maximum again being situated between global and local maxima. These steps may advantageously be algorithmically combined with one another, so that all sought-after variables may be determined by a one-time passage of cost function 210 from left to right (i.e., from small to large disparity parameters). However, it is primarily of interest here that a one-time passage may take place during the determination of the cost function or the respective extreme values. Whether this passage takes place from left to right (small to large) or right to left (large to small) is essentially a matter of view. A periodic structure is present when the largest cost difference of local minima 502, 602 and local maxima 504, 604 is greater than the cost difference of global minimum 224 and of global maximum 506, multiplied by a constant factor, the constant factor in this example corresponding to a value of ¼. This value may be easily implemented by a rapid 2 bit shift operation.

As an alternative, the periodicity parameter may be determined as a function of a value of cost function 210 at a local maximum 504, 604 and a value of cost function 210 at global minimum 224, in particular as a function of a difference from a value of cost function 210 at local maximum 504 and the value of cost function 210 at global minimum 224, a value of cost function 210 at local maximum 504, 604 and a value of cost function 210 at global minimum 224.

Additionally, it should be noted that the approach described here introduces a method for evaluating the cost function in which, in addition to the extreme values, a quality criterion in the form of the periodicity parameter is calculated, which shows or maps the existence of periodic structures in the disparity curve or the cost function. With the aid of this quality criterion, it is possible to determine the plausibility of the global minimum, i.e., of the disparity.

One aspect of the approach described here for the ascertainment of periodic structures is thus based on the evaluation of the cost function. This takes advantage of the fact that periodic structures form a periodic function in the cost function. As a basis in this regard, it may be noted that, with an ideal periodic function (e.g., a sine curve), the values of all maxima and all minima are identical, and thus the difference between two arbitrary minima and maxima is always the same, as was already shown and described in FIG. 4.

In a “beautiful” real periodic function, the difference between the global minimum and the global maximum is only slightly larger than a pair having a large distance between a local minimum and maximum, the local maximum being situated between the global and local minima, as was shown and described with respect to FIG. 5. The difference between the global minimum and maximum is denoted by “DiffCost”, the difference between the local minimum and maximum is denoted by DiffXXXCost, the placeholder XXX being usable with Prey for a minimum/maximum pair having a lower disparity parameter (i.e., the pair preceding the global minimum), or with Next for a minimum/maximum pair having a larger disparity parameter (i.e., the pair following the global minimum). The ratio between DiffCost and DiffXXXCost represents a measure of the periodicity of a function. If the following formula (1) is met, a periodicity in the cost function may be considered to be present:

$$\frac{DiffXXXCost}{DiffCost} > 1 - threshold value \qquad ( 1 )$$

An actual realization of the above-described approach in real surroundings may be implemented as follows: In a real function, the minima and maxima occur in arbitrary positions. Since, in the sought-after pair (i.e., local minimum and local maximum), the local maximum is to be situated between the local minimum and the global minimum, this may occur to the left or right of the global minimum. In FIG. 6, these pairs are shown to the left of the global minimum (bearing the designations MinPrevLoc or 502, and MaxPrevLoc or 504) and to the right of the global minimum (bearing the designations MaxNextLoc or 604, and MinNextLoc or 602). The differences between the left and right local minima/maxima are denoted by DiffPrevCost and DiffNextCost. The global minimum is denoted by Min or 212 and Max or 506, and the difference between the global maximum and the global minimum is denoted by DiffCost. Formula (1) is thus extended into formula (2):

$$\frac{max ( DiffPrevCost , DiffNextCost}{DiffCost} > 1 - threshold value \qquad ( 2 )$$

Since the order between the local minimum and the local maximum is reversed for the left and right pairs, this affects the algorithmic search. The realization of the implementation for the pair search may take place separately from one another.

In this regard, the following procedure has proven suitable:
searching for the absolute minimum (Min) and maximum (Max) and calculating the cost difference (DiffCost)
searching for a local minimum and maximum (*) having a maximum cost difference before the absolute minimum (MinPrevLoc, MaxPrevLoc, DiffPrevCost)
searching for a local minimum and maximum (*) having a maximum cost difference after the absolute minimum (MinNextLoc, MaxNextLoc, DiffNextCost)

These steps may advantageously be algorithmically combined with one another, so that all sought-after variables may be determined during a one-time passage of the cost function from left to right.

A check for the presence of a periodicity may then be calculated as follows:
A periodic structure is present when the largest cost difference of the local minima/maxima is greater than the cost difference of the global minimum/maximum multiplied by a constant factor: Max(DiffPrevCost, DiffNextCost)>DiffCost*(−1−factor) where factor<1 (e.g., factor=¼)

Alternatively, it is also possible to use the following ratio of formula (3) for checking the presence of a periodicity:

$$\frac{\begin{matrix}max ( Cost ( MaxPrevLoc ) - Cost ( Min ) , \\ Cost ( MaxNextLoc ) - Cost ( Min ) )\end{matrix}}{DiffCost} > 1 - threshold value \qquad ( 3 )$$

the designation Cost ( . . . ) being understood to mean the cost function value at the site provided as an argument here.

For example, the following aspects may be mentioned as advantages of the approach described here:
Since the disparity calculation is computationally intensive, preferably simple and fast algorithms are needed to prevent the computing complexity due to the periodicity check from being further inflated. The global minimum is generally easily determined during the passage of the disparity curve from left to right, without computationally intensive regressions.
   The periodicity check may also be ascertained during the passage of the disparity curve from left to right without regressions.
   The periodicity check may be determined simultaneously with the ascertainment of the global minimum.
   Extension: The periodicity check may be determined simultaneously with the ascertainment of the global minimum and a check of the frontoparallelity.
The periodicity check requires only few calculations and variables.
The periodicity check requires only little additional computing time.
The periodicity check is suitable for FPGA implementations.
The good identification of periodic structures in images was able to be successfully demonstrated based on examinations and existing Bosch products.
Only one variable is determined as a measure of the periodicity.
Thus also only one threshold value suffices for this one variable of the periodicity. The threshold value has been of a relatively good nature in the previously examined scenarios. In the present implementation it is assumed to be ¼, since this is easy to implement by a rapid 2 bit shift operation.
The calculation of the periodicity may be carried out using integers.
The result of the check of the presence of a periodicity may be represented by a bit. It therefore requires only little memory space, may be transmitted quickly, and may also be evaluated well in other functions.
The invention is usable for various disparity calculations using a local method, i.e., which compare a sub-section of the “left” to the right image and form a cost function.
The method is also analogously applicable when the value of the cost function does not represent the dissimilarity, but the similarity of the sub-sections, and thus the sought-after disparity value is not the global minimum, but the global maximum.
The method is generally suitable for detecting periodic structures in stereo systems and is not limited to cameras for driver assistance systems.

FIG. 7 shows a flow chart of one exemplary embodiment of a method 700 for activating a driver assistance system using a stereo camera system including a first and a second camera.

In a step 701, a first image from the first camera and a second image from the second camera are read in. In a step 703, a cost function is formed, using the first and the second image. In a step 705, a periodic structure of an object to the periodicity parameter representing the stereo camera system is determined, using at least one local minimum of the cost function. Finally, in a step 707, the periodicity parameter is used to activate the driver assistance system.

If one exemplary embodiment includes an “and/or” linkage between a first feature and a second feature, this is to be read in such a way that the exemplary embodiment according to one specific embodiment includes both the first feature and the second feature, and according to an additional specific embodiment includes either only the first feature or only the second feature.

What is claimed is:

1. A method for activating a driver assistance system using a stereo camera system including a first camera and a second camera, the method comprising:
reading in a first image from the first camera and a second image from the second camera;
forming a cost function, using the first image and the second image;
determining a periodicity parameter representing a periodic structure of an object, at least using a local minimum of the cost function; and
using the periodicity parameter for activating the driver assistance system.

2. The method as recited in claim 1, wherein in the forming step, at least one of: (i) a row of the first camera image is compared to a row of the second camera image, and/or (ii) a column of the first camera image is compared to a column of the second camera image.

3. The method as recited in claim 1, wherein in the determining step, the cost function is determined as a function of a disparity parameter representing a distance of the object from the stereo camera system.

4. The method as recited in claim 3, wherein in the determining step, the disparity parameter is used, which represents a reciprocal measure of the distance of the object from the stereo camera system.

5. The method as recited in claim 1, wherein in the determining, at least one local maximum if the cost function and a global minimum and a global maximum of the cost function is determined, the local maximum being situated between the global minimum and the local minimum.

6. The method as recited in claim 5, wherein in the determining step, the periodicity parameter is determined as a function of a difference of a value of the cost function at the local minimum and a value of the cost function at the local maximum.

7. The method as recited in claim 1, wherein in the determining step, the periodicity parameter is determined as a function of a difference of values of the cost function at at least one adjoining local maximum and minimum.

8. The method as recited in claim 7, wherein in the determining step, the periodicity parameter is determined as a function of a further difference of cost values of an adjoining further local maximum and further local minimum.

9. The method as recited in claim 8, wherein in the determining step, wherein at least one of: (i) the periodicity parameter is determined as a function of a maximum of the difference and the further difference, and/or (ii) the periodicity parameter is determined as a function of the further local maximum and the further local minimum, wherein the global minimum is situated between the further local maximum and the further local minimum on the one hand, and the local maximum and the local minimum on the other hand.

10. The method as recited in claim 1, wherein in the determining step, the periodicity parameter is determined as a function of a value of the cost function at a local maximum and a value of the cost function at the global minimum, the periodicity parameter being determined as a function of a difference of a value of the cost function at the local maximum and the value of the cost function at the global minimum, a value of the cost function at the local maximum and a value of the cost function at the global minimum.

11. The method as recited in claim 1, wherein in the determining step, the periodicity parameter is determined as a function of a ratio of a value of the cost function at the global minimum to a value of the cost function at the global maximum, in particular the ratio as a function of a threshold value representing a measure of the periodicity of the cost function.

12. The method as recited in claim 1, wherein in the determining step, the periodicity parameter is formed as a bit value.

13. A device, which is configured to activate a driver assistance system using a stereo camera system including a first camera and a second camera, the device configured to:
read in a first image from the first camera and a second image from the second camera;
form a cost function, using the first image and the second image;
determine a periodicity parameter representing a periodic structure of an object, at least using a local minimum of the cost function; and
use the periodicity parameter for activating the driver assistance system.

14. A non-transitory machine-readable storage medium on which is stored a computer program for activating a driver assistance system using a stereo camera system including a first camera and a second camera, the computer program, when executed by a computer, causing the computer to perform:
reading in a first image from the first camera and a second image from the second camera;
forming a cost function, using the first image and the second image;
determining a periodicity parameter representing a periodic structure of an object, at least using a local minimum of the cost function; and
using the periodicity parameter for activating the driver assistance system.
